(19) United States
(12) Patent Application Publication
(10) Pub. No.: US 2025/0105713 A1
(43) Pub. Date: Mar. 27, 2025

(54) HAIRPIN PRELIMINARY ALIGNMENT JIG

(71) Applicants: HYUNDAI MOTOR COMPANY, Seoul (KR); KIA CORPORATION, Seoul (KR)

(72) Inventor: Tae Kyun An, Hwaseong-si (KR)

(73) Assignees: HYUNDAI MOTOR COMPANY, Seoul (KR); KIA CORPORATION, Seoul (KR)

(21) Appl. No.: 18/626,548

(22) Filed: Apr. 4, 2024

(30) Foreign Application Priority Data
Sep. 21, 2023 (KR) 10-2023-0126455

(51) Int. Cl. H02K 15/06

(52) U.S. Cl. CPC H02K 15/064; H02K 2215/00

(57) ABSTRACT

A hairpin preliminary alignment jig includes: an inner ring; an outer ring spaced apart radially outward from the inner ring; a plurality of radial members that is arranged radially between the inner ring and the outer ring and defines a plurality of gaps; an inner alignment mechanism disposed on the inner ring. The inner alignment mechanism includes a plurality of inner alignment members configured to align innermost layer hairpins among a plurality of hairpins received in the plurality of gaps. The hairpin preliminary alignment jig further includes an outer alignment mechanism disposed on the outer ring, and the outer alignment mechanism includes a plurality of outer alignment members configured to align outermost layer hairpins among the plurality of hairpins received in the plurality of gaps.

### CROSS-REFERENCE TO RELATED APPLICATION

This application claims the benefit of and priority to Korean Patent Application No. 10-2023-0126455, filed on Sep. 21, 2023, the disclosure of which is incorporated herein in its entirety by reference.

### TECHNICAL FIELD

The present disclosure relates to a hairpin preliminary alignment jig allowing hairpins to be preliminarily aligned before being inserted into a stator core.

### BACKGROUND

A motor may include a stator assembly disposed within a motor housing and a rotor assembly rotatable with respect to the stator assembly. The stator assembly may have a stator core and stator coils wound around the stator core.

Some motors such as a drive motor of an eco-friendly vehicle may employ a hairpin stator, and the hairpin stator may include a stator core having a plurality of slots and a plurality of hairpins inserted into the plurality of slots. Each hairpin may be a conductor. The plurality of hairpins may be electrically conductively connected so that the plurality of hairpins may form a stator coil. Unlike a conventional annular coil having a circular cross-section, the hairpins may be formed to have a quadrilateral cross-section (e.g. a rectangular cross-section) and be characterized by minimizing dead zone within the slots of the stator core and maximizing a space factor of the stator coil.

Each slot of the stator core may extend along a radial direction of the stator core, and the plurality of hairpins inserted into each slot may be arranged in a plurality of layers along the radial direction of the stator core. The models (types) of hairpin stators may be defined depending on the number of layer hairpins.

When the number of layer hairpins inserted into each slot is six, this model may be defined as a 6-layer hairpin stator. The 6-layer hairpin stator includes a first-layer hairpin, a second-layer hairpin, a third-layer hairpin, a fourth-layer hairpin, a fifth-layer hairpin, and a sixth-layer hairpin which are sequentially arranged from the innermost side of each slot to the outermost side of each slot. The first-layer hairpin located in the radially innermost side of each slot is the innermost layer hairpin, and the sixth-layer hairpin located in the radially outermost side of each slot is the outermost layer hairpin.

When the number of layer hairpins inserted into each slot is eight, this model may be defined as an 8-layer hairpin stator. The 8-layer hairpin stator includes a first-layer hairpin, a second-layer hairpin, a third-layer hairpin, a fourth-layer hairpin, a fifth-layer hairpin, a sixth-layer hairpin, a seventh-layer hairpin, and an eighth-layer hairpin which are sequentially arranged from the innermost side of each slot to the outermost side of each slot. The first-layer hairpin located in the radially innermost side of each slot is the innermost layer hairpin, and the eighth-layer hairpin located in the radially outermost side of each slot is the outermost layer hairpin.

When the number of layer hairpins inserted into each slot is ten, this model may be defined as a 10-layer hairpin stator. The 10-layer hairpin stator includes a first-layer hairpin, a second-layer hairpin, a third-layer hairpin, a fourth-layer hairpin, a fifth-layer hairpin, a sixth-layer hairpin, a seventh-layer hairpin, an eighth-layer hairpin, a ninth-layer hairpin, and a tenth-layer hairpin which are sequentially arranged from the innermost side of each slot to the outermost side of each slot. The first-layer hairpin located in the radially innermost side of each slot is the innermost layer hairpin, and the tenth-layer hairpin located in the radially outermost side of each slot is the outermost layer hairpin.

A hairpin winding method may include the steps of: forming hairpins into a specific shape; preliminarily aligning the shaped hairpins with a preliminary alignment jig corresponding to a hairpin stator model; inserting (press-fitting) the preliminarily aligned hairpins into the slots of the stator core; and twisting and welding the bottom ends of the hairpins.

In the preliminarily aligning step, the plurality of hairpins may be primarily aligned in the following manner: the plurality of hairpins formed by a hairpin forming machine may be stacked in a magazine; the plurality of hairpins stacked in the magazine may be sequentially inserted into a cartridge; the hairpins located at the end of the cartridge may be sequentially inserted into the preliminary alignment jig by a robot according to a pattern of the jig.

The preliminary alignment jig may have a plurality of alignment slots corresponding to the slots of the corresponding hairpin stator model. In other words, the alignment slots of the preliminary alignment jig may have the same or similar shape and size as those of the slots of the corresponding hairpin stator model. For example, the alignment slots of the preliminary alignment jig corresponding to the 6-layer hairpin stator may have the same or similar shape and size as those of the slots of the 6-layer hairpin stator. The alignment slots of the preliminary alignment jig corresponding to the 8-layer hairpin stator may have the same or similar shape and size as those of the slots of the 8-layer hairpin stator. The alignment slots of the preliminary alignment jig corresponding to the 10-layer hairpin stator may have the same or similar shape and size as those of the slots of the 10-layer hairpin stator.

In other words, the preliminary alignment jig has the alignment slots with specific shape and size corresponding to the hairpin stator model (the 6-layer hairpin stator, the 8-layer hairpin stator, the 10-layer hairpin stator, or the like). Accordingly, the plurality of preliminary alignment jigs may be provided to match various models of hairpin stators, respectively.

As the plurality of preliminary alignment jigs are provided to match various models of hairpin stators, respectively, a stock apparatus or separate space for storing the plurality of preliminary alignment jigs may be required in a workplace, which may increase the manufacturing costs of the hairpin stators. In addition, it may take time to replace the preliminary alignment jig suitable for the corresponding hairpin stator model in the preliminarily aligning step, which may reduce the productivity of the hairpin stator.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a hairpin preliminary alignment jig designed to vary inner and outer diameters of an annular space between an inner ring and an outer ring, thereby flexibly responding to various models (types) of hairpin stators.

According to an aspect of the present disclosure, a hairpin preliminary alignment jig may include: an inner ring; an outer ring spaced apart radially outward from the inner ring; and a plurality of radial members arranged radially between the inner ring and the outer ring, and configured to define a plurality of gaps. The hairpin preliminary alignment jig may also include an inner alignment mechanism disposed on the inner ring. The inner alignment mechanism includes a plurality of inner alignment members configured to align innermost layer hairpins among a plurality of hairpins received in the plurality of gaps. Additionally, the hairpin preliminary alignment jig may include an outer alignment mechanism disposed on the outer ring. The outer alignment mechanism includes a plurality of outer alignment members configured to align the outermost layer hairpins among the plurality of hairpins received in the plurality of gaps.

The plurality of inner alignment members may be configured to move in a radial direction of the inner ring.

The inner alignment mechanism may include: an inner housing disposed on the inner ring, and an inner cam mounted rotatably on the center of the inner housing. The plurality of inner alignment members may be configured to move radially in the inner housing by rotation of the inner cam.

The inner cam may have a plurality of first cam surfaces and a plurality of second cam surfaces arranged alternately along an outer surface thereof. A distance between the first cam surface and the center of the inner cam may be different from a distance between the second cam surface and the center of the inner cam.

The inner housing may have a plurality of guide blocks provided on a top surface thereof. Each guide block of the plurality of guide blocks may be configured to guide the movement of each inner alignment member of the plurality of inner alignment members.

Each inner alignment member of the plurality of inner alignment members may be biased radially inward by a biasing member.

Each biasing member may be disposed between each respective inner alignment member and the inner housing.

The inner housing may have an annular wall provided at an outer peripheral edge thereof. Each inner alignment member may have a protrusion protruding from a bottom surface thereof, and each biasing member may be disposed between the protrusion of each respective inner alignment member and the annular wall of the inner housing.

The inner alignment mechanism may include an upper inner alignment unit configured to align upper portions of the innermost layer hairpins and a middle inner alignment unit configured to align middle portions of the innermost layer hairpins. The middle inner alignment unit may be connected to the upper inner alignment unit through a connection shaft.

The plurality of outer alignment members may be configured to move in a radial direction in the outer ring.

The outer alignment mechanism may include: an outer housing fixed to a top surface of the outer ring, and an outer cam mounted rotatably on an outer peripheral edge of the outer housing. The plurality of outer alignment members may be configured to move radially in the outer housing by rotation of the outer cam.

The outer cam may have a plurality of first cam surfaces and a plurality of second cam surfaces arranged alternately along an inner peripheral edge thereof. A distance between the first cam surface and the center of the outer cam may be different from a distance between the second cam surface and the center of the outer cam.

The hairpin preliminary alignment jig may further include a plurality of guide pins configured to guide the movement of the plurality of outer alignment members. Each guide pin of the plurality of guide pins may extend radially in the outer housing.

Each outer alignment member of the plurality of outer alignment members may be biased radially outward by a biasing member.

Each biasing member may be disposed between each respective outer alignment member of the plurality of outer alignment members and the outer housing.

The outer housing may have an annular wall provided at an inner peripheral edge thereof. Each outer alignment member of the plurality of outer alignment members may have a protrusion protruding from a bottom surface thereof, and each biasing member may be disposed between the protrusion of each respective outer alignment member of the plurality of outer alignment members and the annular wall of the outer housing.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a perspective view of a hairpin preliminary alignment jig according to an embodiment of the present disclosure;

FIG. 2 illustrates a plan view of a hairpin preliminary alignment jig according to an embodiment of the present disclosure;

FIG. 3 illustrates a cross-sectional view taken along line A-A of FIG. 2;

FIG. 4 illustrates an enlarged view of an upper inner alignment unit as illustrated in FIG. 3;

FIG. 5 illustrates a cross-sectional view taken along line B-B of FIG. 4;

FIG. 6 illustrates a cross-sectional view taken along line C-C of FIG. 2;

FIG. 7 illustrates a cross-sectional perspective view of an upper inner housing of a hairpin preliminary alignment jig according to an embodiment of the present disclosure;

FIG. 8 illustrates a cross-sectional perspective view of a middle inner housing of a hairpin preliminary alignment jig according to an embodiment of the present disclosure;

FIG. 9 illustrates a perspective view of a middle cover of a hairpin preliminary alignment jig according to an embodiment of the present disclosure;

FIG. 10 illustrates a top perspective view of a first upper inner alignment member and a first middle inner alignment member of a hairpin preliminary alignment jig according to an embodiment of the present disclosure;

FIG. 11 illustrates a bottom perspective view of a first upper inner alignment member and a first middle inner alignment member of a hairpin preliminary alignment jig according to an embodiment of the present disclosure;

FIG. 12 illustrates a top perspective view of a second upper inner alignment member and a second middle inner alignment member of a hairpin preliminary alignment jig according to an embodiment of the present disclosure;

FIG. 13 illustrates a bottom perspective view of a second upper inner alignment member and a second middle inner alignment member of a hairpin preliminary alignment jig according to an embodiment of the present disclosure;

FIG. 14 illustrates an enlarged view of a middle inner alignment unit, an outer alignment unit, an outer ring, and an inner ring illustrated in FIG. 3;

FIG. 15 illustrates a cross-sectional view taken along line D-D of FIG. 14;

FIG. 16 illustrates an enlarged view of the middle inner alignment unit illustrated in FIG. 15;

FIG. 17 illustrates a plan view of an outer cam of a hairpin preliminary alignment jig according to an embodiment of the present disclosure;

FIG. 18 illustrates a cross-sectional perspective view of an outer housing of a hairpin preliminary alignment jig according to an embodiment of the present disclosure;

FIG. 19 illustrates an outer alignment member of a hairpin preliminary alignment jig according to an embodiment of the present disclosure;

FIG. 20 illustrates a cross-sectional perspective view of an inner ring and a plurality of radial members of a hairpin preliminary alignment jig according to an embodiment of the present disclosure;

FIG. 21 illustrates a front view of an inner ring and a plurality of radial members of a hairpin preliminary alignment jig according to an embodiment of the present disclosure;

FIG. 22 illustrates a cross-sectional perspective view of a guide ring and a plurality of radial members of a hairpin preliminary alignment jig according to an embodiment of the present disclosure;

FIG. 23 illustrates a front view of a guide ring and a plurality of radial members of a hairpin preliminary alignment jig according to an embodiment of the present disclosure; and

FIG. 24 illustrates a cross-sectional perspective view of an outer ring of a hairpin preliminary alignment jig according to an embodiment of the present disclosure.

### DETAILED DESCRIPTION

Hereinafter, embodiments of the present disclosure are described in detail with reference to the accompanying drawings. In the drawings, the sizes of elements, the thicknesses of lines, and the like may be exaggerated for clarity. In addition, since the terms used herein are defined by considering the functions of the elements in the present disclosure, the terms may vary depending on a user or operator's intention, practice, and the like. Accordingly, the meanings of these should be understood based on the whole context of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or perform that operation or function.

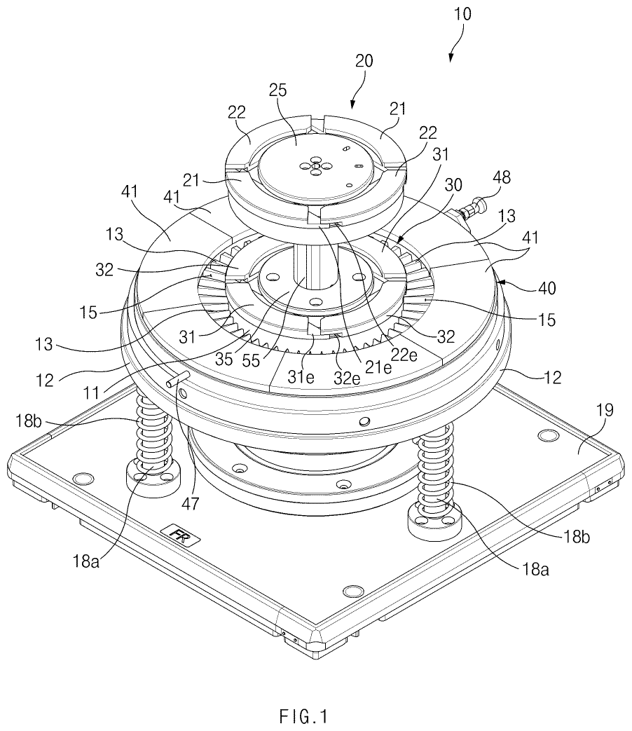

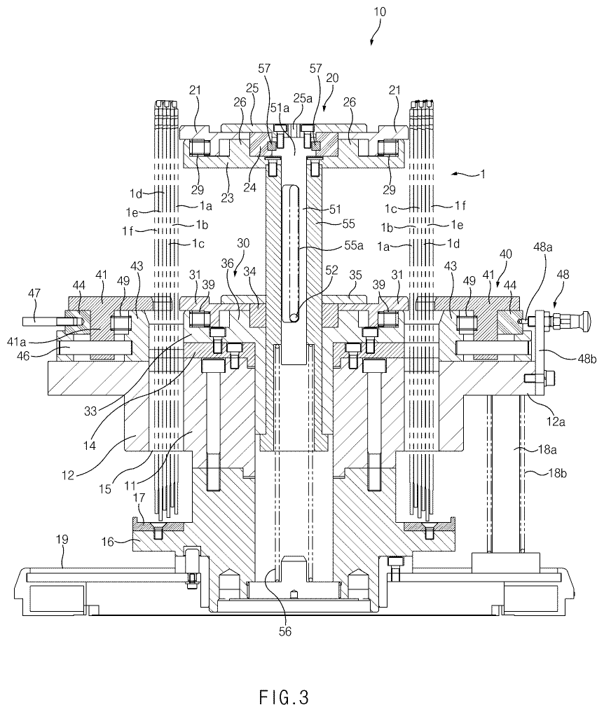

Referring to FIGS. 1 and 3, a hairpin preliminary alignment jig according to an embodiment of the present disclosure may include an inner ring 11, and an outer ring 12 spaced apart radially outward from the inner ring 11. As the outer ring 12 is spaced apart radially outward from the inner ring 11, an annular space may be formed between the inner ring 11 and the outer ring 12.

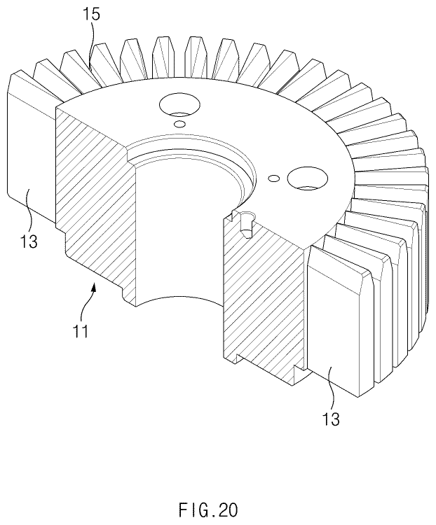

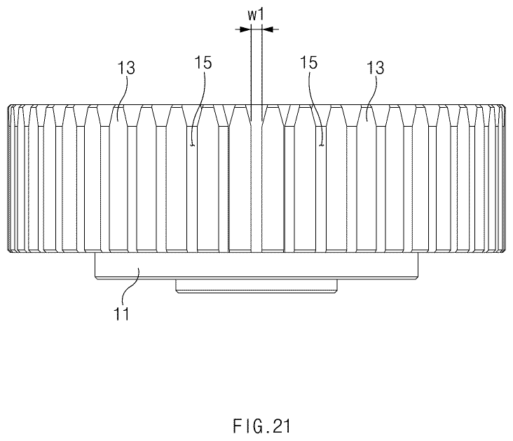

A plurality of radial members 13 may be arranged radially between the inner ring 11 and the outer ring 12. Each radial member 13 may extend in a radial direction between an outer surface of the inner ring 11 and an inner surface of the outer ring 12, and a plurality of gaps 15 may be defined between the plurality of radial members 13. Referring to FIG. 20, the plurality of radial members 13 may extend radially outward from the outer surface of the inner ring 11. Referring to FIG. 21, each gap 15 may be defined between two adjacent radial members 13. The gap 15 may be formed to be slightly greater than a maximum width of a hairpin so as to receive all different types of hairpins. For example, a width of a hairpin used in a 6-layer hairpin stator may be 3.48 mm, a width of a hairpin used in an 8-layer hairpin stator may be 3.27 mm, and a width of a hairpin used in a 10-layer hairpin stator may be 3.21 mm. In other words, the hairpin used in the 6-layer hairpin stator has the maximum width. A width w1 of the gap 15 may be 4 mm slightly greater than 3.48 mm.

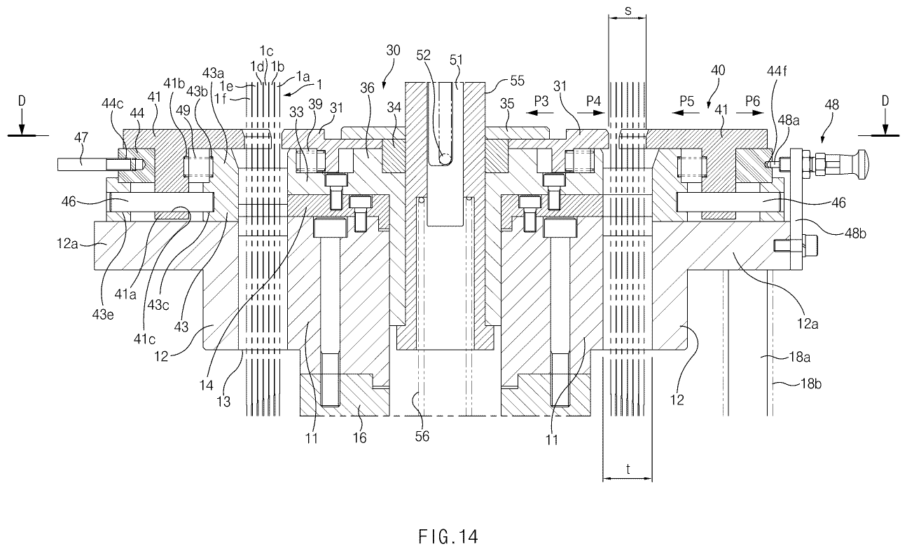

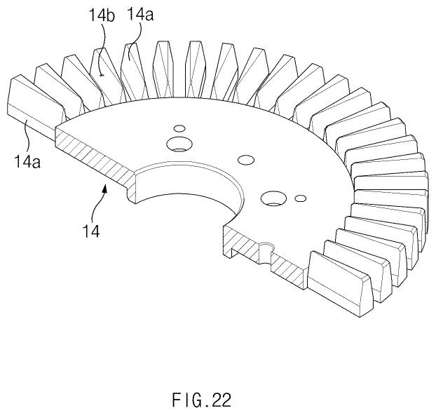

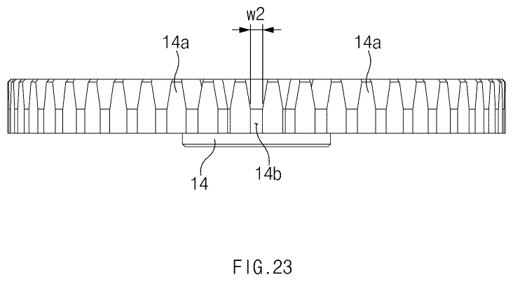

Referring to FIGS. 3 and 14, the hairpin preliminary alignment jig according to an embodiment of the present disclosure may further include a guide ring 14 disposed on the inner ring 11. An outer diameter of the guide ring 14 may be equal to or similar to an outer diameter of the inner ring 11. Referring to FIGS. 22 and 23, a plurality of radial members 14a may extend radially from an outer surface of the guide ring 14, and a gap 14b may be formed between the two adjacent radial members 14a. A width w2 of the gap 14b defined between the radial members 14a of the guide ring 14 may be the same as the width w1 of the gap 15 defined between the radial members 13 of the inner ring 11.

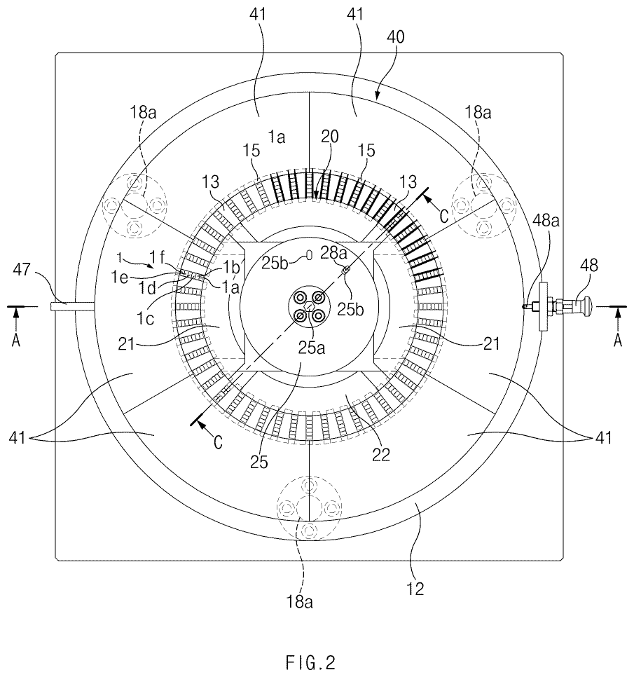

FIGS. 2 and 3 illustrate an example in which each gap 15 receives a 6-layer hairpin set 1 used in the 6-layer hairpin stator. The 6-layer hairpin set 1 may include a first-layer hairpin 1a, a second-layer hairpin 1b, a third-layer hairpin 1c, a fourth-layer hairpin 1d, a fifth-layer hairpin 1e, and a sixth-layer hairpin 1f. Since the first-layer hairpin 1a is located in the radially innermost side of each gap 15, it may be the innermost layer hairpin 1a. Since the sixth-layer hairpin 1f is located in the radially outermost side of each gap 15, it may be the outermost layer hairpin 1f.

Referring to FIG. 3, the inner ring 11 may be supported with respect to a base 19 through a support 16, and a support pad 17 may be provided annularly at an edge of the support 16. The support pad 17 may support the bottom ends of the plurality of hairpins received in the plurality of gaps 15.

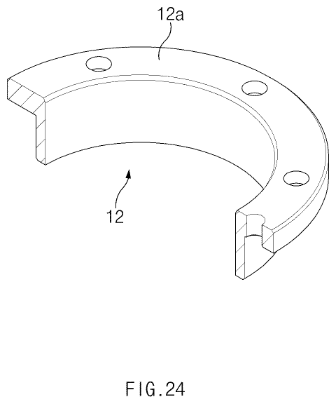

Referring to FIGS. 3 and 24, the outer ring 12 may have an outer annular portion 12a formed at an outer peripheral edge thereof. The outer annular portion 12a may extend annularly along the outer peripheral edge of the outer ring 12. A height of the outer annular portion 12a may be less than a height of the outer ring 12. The outer annular portion 12a may be elastically supported with respect to the base 19 through a plurality of shafts 18a and a plurality of springs 18b. Each spring 18b may be disposed around the corresponding shaft 18a.

Referring to FIG. 1, the hairpin preliminary alignment jig according to an embodiment of the present disclosure may include an inner alignment mechanism 10 configured to align the innermost layer hairpins among the plurality of hairpins received in the plurality of gaps 15.

The inner alignment mechanism 10 may include an upper inner alignment unit 20 and a middle inner alignment unit 30. The upper inner alignment unit 20 may be configured to align the upper portions of the innermost layer hairpins 1a, and the middle inner alignment unit 30 may be configured to align the middle portions of the innermost layer hairpins 1a. The middle inner alignment unit 30 may be located below the upper inner alignment unit 20. In particular, the middle inner alignment unit 30 may be integrally connected to the upper inner alignment unit 20 through a connection shaft 51.

The upper inner alignment unit 20 may include an upper inner housing 23, and a plurality of upper inner alignment members 21 and 22. The plurality of upper inner alignment members 21 and 22 are configured to be movable radially with respect to the inner ring 11 and the upper inner housing 23.

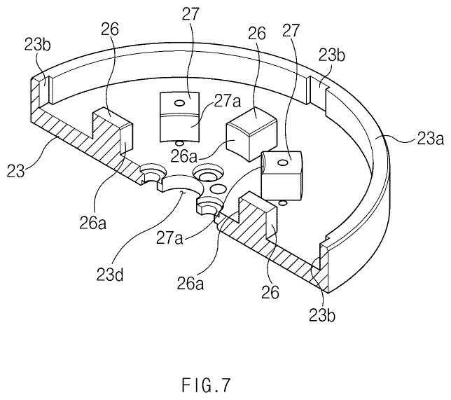

The upper inner housing 23 may be located above the inner ring 11, and an outer diameter of the upper inner housing 23 may be equal to or similar to the outer diameter of the inner ring 11. Referring to FIG. 7, the upper inner housing 23 may have a circular disc shape, and the upper inner housing 23 may include an annular wall 23a provided at an outer peripheral edge thereof. The annular wall 23a may extend annularly along the outer peripheral edge of the upper inner housing 23. Additionally, the annular wall 23a may protrude upward from the outer peripheral edge of the upper inner housing 23. The upper inner housing 23 may have a plurality of retainer recesses 23b formed in an inner peripheral surface of the annular wall 23a, and the plurality of retainer recesses 23b may correspond to the plurality of upper inner alignment members 21 and 22, respectively. The upper inner housing 23 may have a plurality of guide blocks 26 protruding upward from a top surface thereof. The annular wall 23a may surround the plurality of guide blocks 26, and the plurality of guide blocks 26 may be spaced apart from each other along a circumferential direction of the upper inner housing 23. The guide blocks 26 may be configured to guide the radial movement of the upper inner alignment members 21 and 22. In addition, the upper inner housing 23 may further include a plurality of support blocks 27 disposed between the plurality of guide blocks 26. The plurality of support blocks 27 and the plurality of guide blocks 26 may be arranged alternately along the circumferential direction of the upper inner housing 23. Furthermore, the upper inner housing 23 may have a through hole 23d provided in a central portion thereof, and the connection shaft 51 may extend through the through hole 23d of the upper inner housing 23.

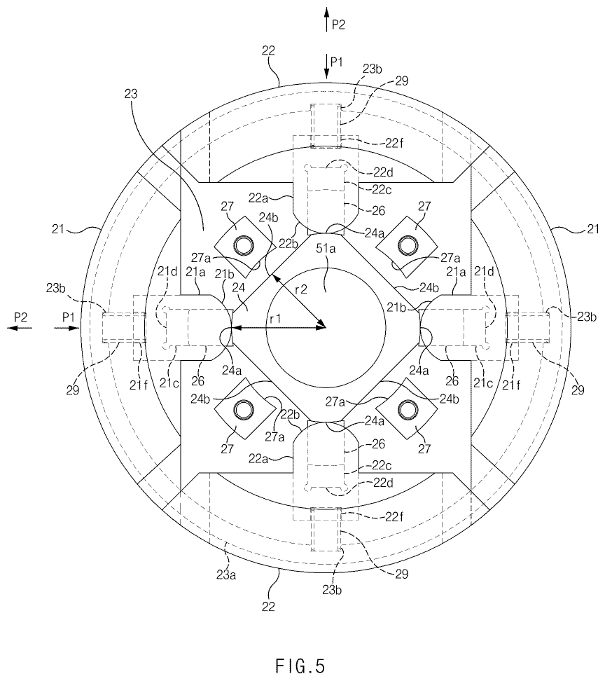

Referring to FIG. 5, the upper inner alignment unit 20 may include an upper inner cam 24 mounted rotatably on the center of the upper inner housing 23. The upper inner cam 24 may have a plurality of first cam surfaces 24a and a plurality of second cam surfaces 24b formed on an outer surface thereof. The plurality of first cam surfaces 24a and the plurality of second cam surfaces 24b may be arranged alternately along the outer surface of the upper inner cam 24. A distance r1 between the first cam surface 24a and the center of the upper inner cam 24 may be different from a distance r2 between the second cam surface 24b and the center of the upper inner cam 24. The first cam surface 24a may be curved with a predetermined radius of curvature, and the second cam surface 24b may be a flat surface. The distance r1 between the first cam surface 24a and the center of the upper inner cam 24 may be greater than the distance r2 between the second cam surface 24b and the center of the upper inner cam 24. Accordingly, the first cam surface 24a may be located farther from the center of the upper inner cam 24 than the second cam surface 24b. The first cam surface 24a may protrude further from the center of the upper inner cam 24 than the second cam surface 24b. The plurality of first cam surfaces 24a and the plurality of second cam surfaces 24b may be configured to selectively contact the plurality of upper inner alignment members 21 and 22 by the rotation of the upper inner cam 24.

Referring to FIG. 7, each guide block 26 may have a guide surface 26a curved to match the first cam surface 24a of the upper inner cam 24. Each support block 27 may have a guide surface 27a curved to match the first cam surface 24a of the upper inner cam 24. Accordingly, the rotation of the upper inner cam 24 may be guided along the guide surfaces 26a of the guide blocks 26 and the guide surfaces 27a of the support blocks 27.

The plurality of upper inner alignment members 21 and 22 may directly contact the upper portions of the innermost layer hairpins 1a to thereby align the upper portions of the innermost layer hairpins 1a. Referring to FIG. 5, the plurality of upper inner alignment members 21 and 22 may be configured to move radially in the upper inner housing 23 by the rotation of the upper inner cam 24. The radial movement of the plurality of upper inner alignment members 21 and 22 may be guided by the plurality of guide blocks 26. As the plurality of upper inner alignment members 21 and 22 move in the radial direction, an inner diameter of the annular space between the inner ring 11 and the outer ring 12 may be varied.

The plurality of upper inner alignment members 21 and 22 may include a plurality of first upper inner alignment members 21 and a plurality of second upper inner alignment members 22 arranged alternately along the circumferential direction of the upper inner housing 23. The plurality of first upper inner alignment members 21 may be symmetrical with respect to the center of the upper inner housing 23, and the plurality of second upper inner alignment members 22 may be symmetrical with respect to the center of the upper inner housing 23. Each first upper inner alignment member 21 may be disposed between the two adjacent second upper inner alignment members 22, and each second upper inner alignment member 22 may be disposed between the two adjacent first upper inner alignment members 21. Referring to FIG. 5, the upper inner cam 24 may be disposed at the center of the upper inner housing 23, the two first upper inner alignment members 21 may be symmetrical with respect to the center of the upper inner housing 23, and the two second upper inner alignment members 22 may be symmetrical with respect to the center of the upper inner housing 23. As the upper inner cam 24 rotates, the two first upper inner alignment members 21 and the two second upper inner alignment members 22 may move in the radial direction of the upper inner housing 23.

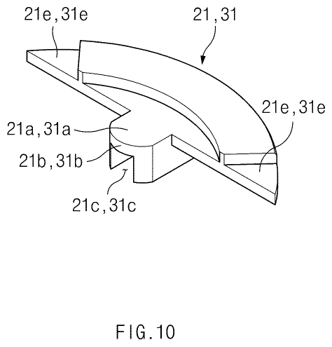

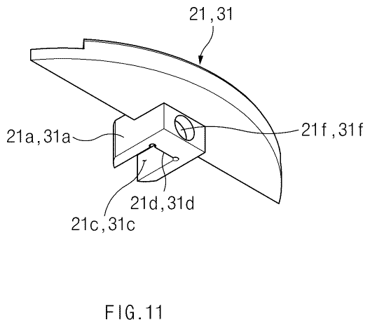

The first upper inner alignment member 21 may have a protrusion 21a extending toward the center of the upper inner housing 23. Referring to FIGS. 10 and 11, the protrusion 21a may protrude downward from a bottom surface of the first upper inner alignment member 21. The protrusion 21a may have a first end portion facing the center of the upper inner housing 23, and a second end portion facing the outer peripheral edge of the upper inner housing 23.

Referring to FIGS. 10 and 11, each first upper inner alignment member 21 may have a cavity 21c defined in the protrusion 21a, and the cavity 21c may be open to the center of the upper inner housing 23. A stopper surface 21d may be provided in the cavity 21c, and the stopper surface 21d may be adjacent to the second end portion of the protrusion 21a. Referring to FIG. 5, the cavity 21c of each first upper inner alignment member 21 of the first upper inner alignment members 21 may receive each corresponding guide block 26, and a length of the cavity 21c may be greater than a length of the corresponding guide block 26. Accordingly, the radial movement of the first upper inner alignment member 21 may be guided by the guide block 26. The stopper surface 21d of the cavity 21c of the first upper inner alignment member 21 may contact the guide block 26 so that the position of the first upper inner alignment member 21 may be restricted by the stopper surface 21d and the guide block 26. The first upper inner alignment member 21 may have a

contact surface 21b formed on the first end portion of the protrusion 21a. The contact surface 21b of the first upper inner alignment member 21 may selectively contact the first cam surface 24a and the second cam surface 24b of the upper inner cam 24 by the rotation of the upper inner cam 24. According to an embodiment, the contact surface 21b may be a curved surface with a predetermined radius of curvature.

The first upper inner alignment member 21 may be biased radially inward by a biasing member 29. According to an embodiment, the biasing member 29 may be a coil spring disposed between the annular wall 23a of the upper inner housing 23 and each first upper inner alignment member 21.

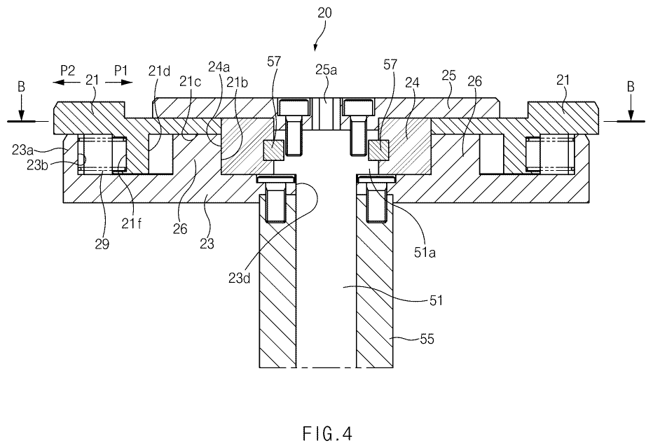

Referring to FIGS. 4 and 5, the biasing member 29 may be disposed between the protrusion 21a of the first upper inner alignment member 21 and the annular wall 23a of the upper inner housing 23 so that the first upper inner alignment member 21 may be biased radially inward by the biasing member 29. Referring to FIG. 11, the first upper inner alignment member 21 may have a retainer recess 21f formed in the second end portion of the protrusion 21a. Referring to FIGS. 4 and 5, the retainer recess 23b of the upper inner housing 23 may face the corresponding retainer recess 21f of the first upper inner alignment member 21, one end of the biasing member 29 may be supported to the retainer recess 21f of the first upper inner alignment member 21, and the other end of the biasing member 29 may be supported to the retainer recess 23b of the upper inner housing 23.

When the second cam surface 24b of the upper inner cam 24 contacts a central portion of the contact surface 21b of the first upper inner alignment member 21 by the rotation of the upper inner cam 24, the first upper inner alignment member 21 may move radially inward (see P1 in FIGS. 4 and 5) of the upper inner housing 23 by extension of the biasing member 29, and the first upper inner alignment member 21 may be in a first position relatively close to the center of the upper inner housing 23.

When the first cam surface 24a of the upper inner cam 24 contacts the central portion of the contact surface 21b of the first upper inner alignment member 21 by the rotation of the upper inner cam 24, the first upper inner alignment member 21 may move radially outward (see P2 in FIGS. 4 and 5) of the upper inner housing 23. As the biasing member 29 is compressed, the first upper inner alignment member 21 may move to a second position relatively far from the center of the upper inner housing 23.

Accordingly, the plurality of first upper inner alignment members 21 may move in the radial direction by the rotation of the upper inner cam 24.

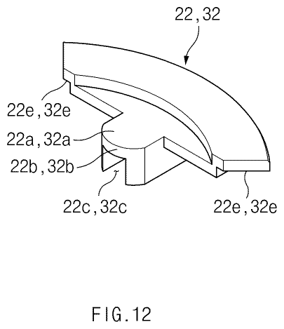

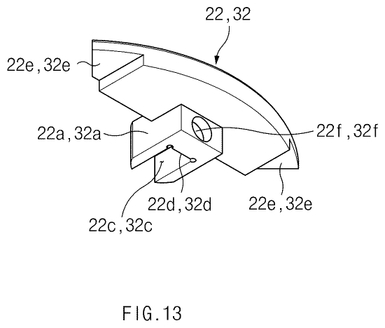

The second upper inner alignment member 22 may have a protrusion 22a extending toward the center of the upper inner housing 23. Referring to FIGS. 12 and 13, the protrusion 22a may protrude downward from a bottom surface of the second upper inner alignment member 22. The protrusion 22a may have a first end portion facing the center of the upper inner housing 23, and a second end portion facing the outer peripheral edge of the upper inner housing 23.

Referring to FIGS. 12 and 13, each second upper inner alignment member 22 may have a cavity 22c defined in the protrusion 22a, and the cavity 22c may be open to the center of the upper inner housing 23. A stopper surface 22d may be provided in the cavity 22c, and the stopper surface 22d may be adjacent to the second end portion of the protrusion 22a. Referring to FIG. 5, the cavity 22c of the second upper inner alignment member 22 may receive the corresponding guide block 26, and a length of the cavity 22c may be greater than the length of the guide block 26. Accordingly, the radial movement of the second upper inner alignment member 22 may be guided by the guide block 26. The stopper surface 22d of the cavity 22c of the second upper inner alignment member 22 may contact the guide block 26 so that the position of the second upper inner alignment member 22 may be restricted by the stopper surface 22d and the guide block 26.

The second upper inner alignment member 22 may have a contact surface 22b formed on the first end portion of the protrusion 22a, and the contact surface 22b of the second upper inner alignment member 22 may selectively contact the first cam surface 24a and the second cam surface 24b of the upper inner cam 24 by the rotation of the upper inner cam 24. According to an embodiment, the contact surface 22b may be a curved surface with a predetermined radius of curvature.

The second upper inner alignment member 22 may be biased radially inward by the biasing member 29. According to an embodiment, the biasing member 29 may be a coil spring disposed between the annular wall 23a of the upper inner housing 23 and each second upper inner alignment member 22.

Referring to FIGS. 4 and 5, the biasing member 29 may be disposed between the protrusion 22a of the second upper inner alignment member 22 and the annular wall 23a of the upper inner housing 23 so that the second upper inner alignment member 22 may be biased radially inward by the biasing member 29. Referring to FIG. 13, the second upper inner alignment member 22 may have a retainer recess 22f formed in the second end portion of the protrusion 22a. Referring to FIGS. 4 and 5, the retainer recess 23b of the upper inner housing 23 may face the corresponding retainer recess 22f of the second upper inner alignment member 22, one end of the biasing member 29 may be supported to the retainer recess 22f of the second upper inner alignment member 22, and the other end of the biasing member 29 may be supported to the retainer recess 23b of the upper inner housing 23.

When the second cam surface 24b of the upper inner cam 24 contacts a central portion of the contact surface 22b of the second upper inner alignment member 22 by the rotation of the upper inner cam 24, the second upper inner alignment member 22 may move radially inward (see P1 in FIGS. 4 and 5) of the upper inner housing 23 by extension of the biasing member 29, and the second upper inner alignment member 22 may be in a first position relatively close to the center of the upper inner housing 23.

When the first cam surface 24a of the upper inner cam 24 contacts the central portion of the contact surface 22b of the second upper inner alignment member 22 by the rotation of the upper inner cam 24, the second upper inner alignment member 22 may move radially outward (see P2 in FIGS. 4 and 5) of the upper inner housing 23. As the biasing member 29 is compressed, the second upper inner alignment member 22 may move to a second position relatively far from the center of the upper inner housing 23.

Accordingly, the plurality of second upper inner alignment members 22 may move in the radial direction by the rotation of the upper inner cam 24.

When the plurality of first upper inner alignment members 21 and the plurality of second upper inner alignment members 22 move in the radial direction, both end portions of each first upper inner alignment member 21 may not interfere with both end portions of the adjacent second upper inner alignment member 22. Referring to FIG. 10, the first upper inner alignment member 21 may have a pair of guide surfaces 21e formed on both end portions thereof. Referring to FIG. 12, the second upper inner alignment member 22 may have a pair of guide surfaces 22e formed on both end portions thereof. Referring to FIG. 1, the guide surfaces 21e of the first upper inner alignment member 21 may be aligned with the guide surfaces 22e of the second upper inner alignment member 22, and the guide surfaces 21e of the first upper inner alignment member 21 may contact the guide surfaces 22e of the second upper inner alignment member 22. The radial movement of the first upper inner alignment member 21 and the second upper inner alignment member 22 may be precisely guided by the guide surfaces 21e of the first upper inner alignment member 21 and the guide surfaces 22e of the second upper inner alignment member 22.

The middle inner alignment unit 30 may include a middle inner housing 33, and a plurality of middle inner alignment members 31 and 32 movable radially with respect to the inner ring 11 and the middle inner housing 33.

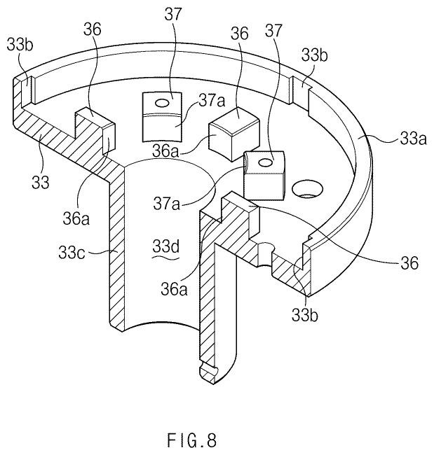

The middle inner housing 33 may be located above the inner ring 11, and an outer diameter of the middle inner housing 33 may be equal to or similar to the outer diameter of the inner ring 11. Referring to FIGS. 3 and 14, the middle inner housing 33 may be fixed to the guide ring 14 using a plurality of fasteners. Referring to FIG. 8, the middle inner housing 33 may have a circular disc shape, and the middle inner housing 33 may include an annular wall 33a provided at an outer peripheral edge thereof. The annular wall 33a may extend annularly along the outer peripheral edge of the middle inner housing 33, and the annular wall 33a may protrude upward from the outer peripheral edge of the middle inner housing 33. The middle inner housing 33 may have a plurality of recesses 33b formed in an inner peripheral surface of the annular wall 33a, and the plurality of recesses 33b may be aligned with the plurality of middle inner alignment members 31 and 32, respectively. The middle inner housing 33 may have a plurality of guide blocks 36 protruding upward from a top surface thereof. The annular wall 33a may surround the plurality of guide blocks 36, and the plurality of guide blocks 36 may be spaced apart from each other along a circumferential direction of the middle inner housing 33. The guide blocks 36 may be configured to guide the radial movement of the middle inner alignment members 31 and 32. In addition, the middle inner housing 33 may further include a plurality of support blocks 37 disposed between the plurality of guide blocks 36. The plurality of support blocks 37 and the plurality of guide blocks 36 may be arranged alternately along the circumferential direction of the middle inner housing 33. Furthermore, the middle inner housing 33 may have a cylindrical portion 33c extending downward from a central portion thereof. The cylindrical portion 33c may have a cavity 33d defined therein. The connection shaft 51 and a lifting shaft 55 described further below may be received in the cavity 33d of the middle inner housing 33.

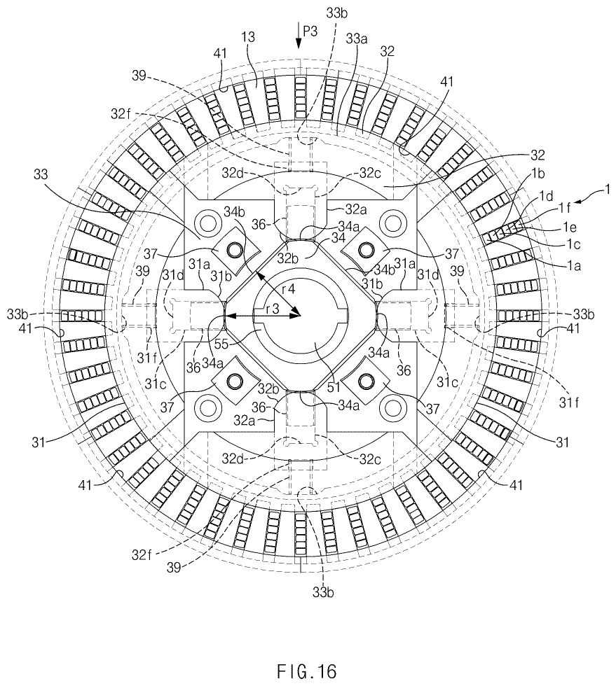

Referring to FIG. 14, the middle inner alignment unit 30 may include a middle inner cam 34 mounted rotatably on the center of the middle inner housing 33. Referring to FIG. 16, the middle inner cam 34 may have a plurality of first cam surfaces 34a and a plurality of second cam surfaces 34b formed on an outer surface thereof. The plurality of first cam surfaces 34a and the plurality of second cam surfaces 34b may be arranged alternately along the outer surface of the middle inner cam 34. A distance r3 between the first cam surface 34a and the center of the middle inner cam 34 may be different from a distance r4 between the second cam surface 34b and the center of the middle inner cam 34. The first cam surface 34a may be curved with a predetermined radius of curvature, and the second cam surface 34b may be a flat surface. The distance r3 between the first cam surface 34a and the center of the middle inner cam 34 may be greater than the distance r4 between the second cam surface 34b and the center of the middle inner cam 34. Accordingly the first cam surface 34a may be located farther from the center of the middle inner cam 34 than the second cam surface 34b, and the first cam surface 34a may protrude further from the center of the middle inner cam 34 than the second cam surface 34b. The plurality of first cam surfaces 34a and the plurality of second cam surfaces 34b may be configured to selectively contact the plurality of middle inner alignment members 31 and 32 by the rotation of the middle inner cam 34.

Referring to FIG. 8, each guide block 36 may have a guide surface 36a curved to match the first cam surface 34a of the middle inner cam 34, and each support block 37 may have a guide surface 37a curved to match the first cam surface 34a of the middle inner cam 34. Accordingly, the rotation of the middle inner cam 34 may be guided along the guide surfaces 36a of the guide blocks 36 and the guide surfaces 37a of the support blocks 37.

The plurality of middle inner alignment members 31 and 32 may directly contact the middle portions of the innermost layer hairpins 1a to thereby align the middle portions of the innermost layer hairpins 1a. Referring to FIG. 16, the plurality of middle inner alignment members 31 and 32 may be configured to move radially in the middle inner housing 33. The radial movement of the plurality of middle inner alignment members 31 and 32 may be guided by the plurality of guide blocks 36. As the plurality of middle inner alignment members 31 and 32 move in the radial direction, the inner diameter of the annular space between the inner ring 11 and the outer ring 12 may be varied.

The plurality of middle inner alignment members 31 and 32 may include a plurality of first middle inner alignment members 31 and a plurality of second middle inner alignment members 32 arranged alternately along the circumferential direction of the middle inner housing 33. The plurality of first middle inner alignment members 31 may be symmetrical with respect to the center of the middle inner housing 33. The plurality of second middle inner alignment members 32 may be symmetrical with respect to the center of the middle inner housing 33. Each first middle inner alignment member 31 may be disposed between the two adjacent second middle inner alignment members 32, and each second middle inner alignment member 32 may be disposed between the two adjacent first middle inner alignment members 31. Referring to FIG. 16, the middle inner cam 34 may be disposed at the center of the middle inner housing 33, and the two first middle inner alignment members 31 may be symmetrical with respect to the center of the middle inner housing 33, and the two second middle inner alignment members 32 may be symmetrical with respect to the center of the middle inner housing 33. As the middle inner cam 34 rotates, the two first middle inner alignment members 31 and the two second middle inner alignment members 32 may move in the radial direction of the middle inner housing 33.

Each first middle inner alignment member 31 may have a protrusion 31a extending toward the center of the middle inner housing 33. Referring to FIGS. 10 and 11, the protrusion 31a may protrude downward from a bottom surface of the first middle inner alignment member 31. The protrusion 31a may have a first end portion facing the center of the middle inner housing 33, and a second end portion facing the outer peripheral edge of the middle inner housing 33.

Referring to FIGS. 10 and 11, each first middle inner alignment member 31 may have a cavity 31c defined in the protrusion 31a, and the cavity 31c may be open to the center of the middle inner housing 33. A stopper surface 31d may be provided in the cavity 31c, and the stopper surface 31d may be adjacent to the second end portion of the protrusion 31a. Referring to FIG. 16, the cavity 31c of each first middle inner alignment member 31 may receive the corresponding guide block 36 of the guide blocks 36, and a length of the cavity 31c may be greater than a length of the corresponding guide block 36. Accordingly, the radial movement of the first middle inner alignment member 31 may be guided by the guide block 36. The stopper surface 31d of the cavity 31c of the first middle inner alignment member 31 may contact the guide block 36 so that the position of the first middle inner alignment member 31 may be restricted by the stopper surface 31d and the guide block 36.

The first middle inner alignment member 31 may have a contact surface 31b formed on the first end portion of the protrusion 31a. The contact surface 31b of the first middle inner alignment member 31 may selectively contact the first cam surface 34a and the second cam surface 34b of the middle inner cam 34 by the rotation of the middle inner cam 34. According to an embodiment, the contact surface 31b may be a curved surface with a predetermined radius of curvature.

The first middle inner alignment member 31 may be biased radially inward by a biasing member 39. According to an embodiment, the biasing member 39 may be a coil spring disposed between the annular wall 33a of the middle inner housing 33 and each first middle inner alignment member 31.

Referring to FIG. 16, the biasing member 39 may be disposed between the protrusion 31a of the first middle inner alignment member 31 and the annular wall 33a of the middle inner housing 33 so that the first middle inner alignment member 31 may be biased radially inward by the biasing member 39. Referring to FIG. 8, the middle inner housing 33 may have the plurality of recesses 33b provided in the inner peripheral surface of the annular wall 33a. Referring to FIG. 11, the first middle inner alignment member 31 may have a recess 31f formed in the second end portion of the protrusion 31a. Referring to FIG. 16, the recess 33b of the middle inner housing 33 may face the corresponding recess 31f of the first middle inner alignment member 31. One end of the biasing member 39 may be supported to the recess 31f of the first middle inner alignment member 31, and the other end of the biasing member 39 may be supported to the recess 33b of the middle inner housing 33.

When the second cam surface 34b of the middle inner cam 34 contacts a central portion of the contact surface 31b of the first middle inner alignment member 31 by the rotation of the middle inner cam 34, the first middle inner alignment member 31 may move radially inward (see P3 in FIGS. 14 and 16) of the middle inner housing 33 by extension of the biasing member 39, and the first middle inner alignment member 31 may be in a first position relatively close to the center of the middle inner housing 33.

When the first cam surface 34a of the middle inner cam 34 contacts the central portion of the contact surface 31b of the first middle inner alignment member 31 by the rotation of the middle inner cam 34, the first middle inner alignment member 31 may move radially outward (see P4 in FIGS. 14 and 16) of the middle inner housing 33. As the biasing member 39 is compressed, the first middle inner alignment member 31 may move to a second position relatively far from the center of the middle inner housing 33.

Accordingly, the plurality of first middle inner alignment members 31 may move radially in the middle inner housing 33 by the rotation of the middle inner cam 34.

The second middle inner alignment member 32 may have a protrusion 32a extending toward the center of the middle inner housing 33. Referring to FIGS. 12 and 13, the protrusion 32a may protrude downward from a bottom surface of the second middle inner alignment member 32. The protrusion 32a may have a first end portion facing the center of the middle inner housing 33, and a second end portion facing the outer peripheral edge of the middle inner housing 33.

Referring to FIGS. 12 and 13, each second middle inner alignment member 32 may have a cavity 32c defined in the protrusion 32a, and the cavity 32c may be open to the center of the middle inner housing 33. A stopper surface 32d may be provided in the cavity 32c, and the stopper surface 32d may be adjacent to the second end portion of the protrusion 32a. Referring to FIG. 16, the cavity 32c of each second middle inner alignment member 32 may receive the corresponding guide block 36, and a length of the cavity 32c may be greater than the length of the corresponding guide block 36. Accordingly, the radial movement of the second middle inner alignment member 32 may be guided by the guide block 36. The stopper surface 32d of the cavity 32c of the second middle inner alignment member 32 may contact the guide block 36 so that the position of the second middle inner alignment member 32 may be restricted by the stopper surface 32d and the guide block 36.

The second middle inner alignment member 32 may have a contact surface 32b formed on the first end portion of the protrusion 32a. The contact surface 32b of the second middle inner alignment member 32 may selectively contact the first cam surface 34a and the second cam surface 34b of the middle inner cam 34 by the rotation of the middle inner cam 34. According to an embodiment, the contact surface 32b may be a curved surface with a predetermined radius of curvature.

The second middle inner alignment member 32 may be biased radially inward by the biasing member 39. According to an embodiment, the biasing member 39 may be a coil spring disposed between the annular wall 33a of the middle inner housing 33 and each second middle inner alignment member 32.

Referring to FIG. 16, the biasing member 39 may be disposed between the protrusion 32a of the second middle inner alignment member 32 and the annular wall 33a of the middle inner housing 33 so that the second middle inner alignment member 32 may be biased radially inward by the biasing member 39. Referring to FIG. 13, the second middle inner alignment member 32 may have a recess 32f formed in the second end portion of the protrusion 32a. Referring to FIG. 16, the recess 33b of the middle inner housing 33 may face the corresponding recess 32f of the second middle inner alignment member 32. One end of the biasing member 39 may be supported to the recess 32f of the second middle inner alignment member 32, and the other end of the biasing member 39 may be supported to the recess 33b of the middle inner housing 33.

When the second cam surface 34b of the middle inner cam 34 contacts a central portion of the contact surface 32b of the second middle inner alignment member 32 by the rotation of the middle inner cam 34, the second middle inner alignment member 32 may move radially inward (see P3 in FIGS. 14 and 16) of the middle inner housing 33 by extension of the biasing member 39. The second middle inner alignment member 32 may be in a first position relatively close to the center of the middle inner housing 33.

When the first cam surface 34a of the middle inner cam 34 contacts the central portion of the contact surface 32b of the second middle inner alignment member 32 by the rotation of the middle inner cam 34, the second middle inner alignment member 32 may move radially outward (see P4 in FIGS. 14 and 16) of the middle inner housing 33. As the biasing member 39 is compressed, the second middle inner alignment member 32 may move to a second position relatively far from the center of the middle inner housing 33.

Accordingly, the plurality of second middle inner alignment members 32 may move radially in the middle inner housing 33 by the rotation of the middle inner cam 34.

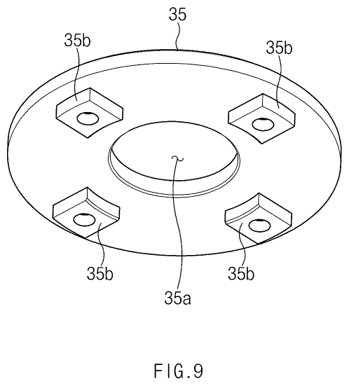

Referring to FIGS. 3 and 14, the middle inner alignment unit 30 according to an embodiment of the present disclosure may include a middle cover 35 covering the middle inner housing 33. Referring to FIG. 9, the middle cover 35 may include a through hole 35a provided in a central portion thereof, and a plurality of support blocks 35b protruding downward from a bottom surface thereof. The lifting shaft 55 described further below and the connection shaft 51 may extend through the through hole 35a of the middle cover 35. The support blocks 35b of the middle cover 35 may be fixed to the support blocks 37 of the middle inner housing 33 using fasteners so that the middle cover 35 may be mounted on the middle inner housing 33.

When the plurality of first middle inner alignment members 31 and the plurality of second middle inner alignment members 32 move in the radial direction, both end portions of each first middle inner alignment member 31 may not interfere with both end portions of the adjacent second middle inner alignment member 32. Referring to FIG. 10, the first middle inner alignment member 31 may have a pair of guide surfaces 31e formed on both end portions thereof. Referring to FIG. 12, the second middle inner alignment member 32 may have a pair of guide surfaces 32e formed on both end portions thereof. Referring to FIG. 1, the guide surfaces 31e of the first middle inner alignment member 31 may be aligned with the guide surfaces 32e of the second middle inner alignment member 32. The guide surfaces 31e of the first middle inner alignment member 31 may contact the guide surfaces 32e of the second middle inner alignment member 32. The radial movement of the first middle inner alignment member 31 and the second middle inner alignment member 32 may be precisely guided by the guide surfaces 31e of the first middle inner alignment member 31 and the guide surfaces 32e of the second middle inner alignment member 32.

The inner alignment mechanism 10 according to an embodiment of the present disclosure may include the connection shaft 51 connecting the upper inner alignment unit 20 and the middle inner alignment unit 30. The connection shaft 51 may integrally connect the middle inner cam 34 of the middle inner alignment unit 30 and the upper inner cam 24 of the upper inner alignment unit 20. Accordingly, the middle inner cam 34 may rotate together with the upper inner cam 24 in the same direction through the connection shaft 51.

Referring to FIGS. 2 and 3, the upper inner alignment unit 20 may include an upper cover 25 covering the upper inner cam 24. The upper cover 25 may have a hole 25a provided in a central portion thereof. The hole 25a may be formed to have a square, hexagonal, or octagonal shape. An operation tool such as a square wrench, a hexagonal wrench, or an octagonal wrench may be inserted into the hole 25a. As an operator turns the operation tool, the upper cover 25 may be manually rotated.

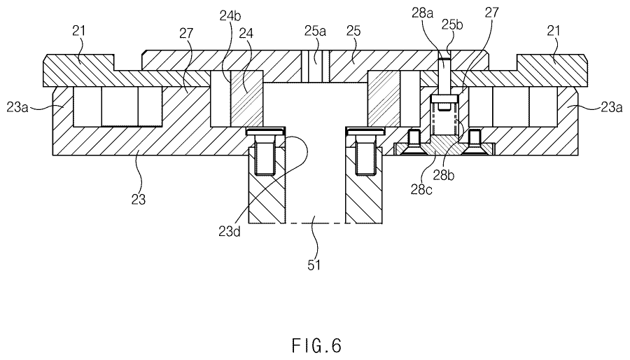

Referring to FIG. 6, the upper inner alignment unit 20 may include at least one positioning pin 28a mounted in at least one of the support blocks 27 of the upper inner housing 23. The positioning pin 28a may be biased upward by a spring 28b. The support block 27 may have a cavity defined therein, and a lower portion of the positioning pin 28a and the spring 28b may be disposed in the cavity of the support block 27. A support cover 28c may be mounted on the upper inner housing 23 through a fastener to close the cavity of the support block 27.

Referring to FIG. 2, the upper cover 25 may have at least two positioning holes 25b, and the two positioning holes 25b may be spaced apart from each other by a predetermined gap. Specifically, the two positioning holes 25b may be spaced apart from each other at an angle corresponding to an angle between the first cam surface 24a and the second cam surface 24b of the upper inner cam 24. In addition, the first upper inner alignment member 21 and the second upper inner alignment member 22 may have through holes corresponding to the positioning holes 25b, respectively.

When the plurality of first upper inner alignment members 21 contact any one of the first cam surface 24a and the second cam surface 24b of the upper inner cam 24 by the rotation of the upper inner cam 24, the positioning pin 28a may pass through the corresponding through hole of the upper inner alignment members 21 and 22 and be inserted into any one of the two positioning holes 25b. Thus, the plurality of upper inner alignment members 21 and 22, the upper cover 25, and the upper inner cam 24 may be accurately positioned.

Referring to FIGS. 3 and 4, the upper cover 25 may be fixed to a head portion 51a of the connection shaft 51 through a plurality of fasteners. The upper inner cam 24 may be fixed to the head portion 51a of the connection shaft 51 through a fixed pin 57. Furthermore, the middle inner cam 34 of the middle inner alignment unit 30 may be fixed to a lower portion of the connection shaft 51 through a fixed pin 52.

Accordingly, the upper cover 25, the upper inner cam 24, the connection shaft 51, and the middle inner cam 34 may be integrally connected to each other. As the upper cover 25 rotates, the upper inner cam 24, the connection shaft 51, and the middle inner cam 34 may rotate in the same direction as the rotation direction of the upper cover 25.

A height of the upper inner alignment unit 20 may be adjusted by the lifting shaft 55 and a retention mechanism (not shown). The lifting shaft 55 may be configured to elastically support the upper inner alignment unit 20. A top end of the lifting shaft 55 may be fixed to the upper inner housing 23 of the upper inner alignment unit 20 through a fastener. The lifting shaft 55 may have a cavity defined therein, and the connection shaft 51 may be received in the cavity of the lifting shaft 55. The lifting shaft 55 may be elastically supported by a spring 56. The spring 56 may be disposed between a bottom end of the lifting shaft 55 and the base 19. A top end of the spring 56 may be supported to the bottom end of the lifting shaft 55, and a bottom end of the spring 56 may be supported to the base 19. Accordingly, the upper inner alignment unit 20 may be elastically supported by the lifting shaft 55 and the spring 56. The lifting shaft 55 may have a pair of slots 55a, and a portion of the fixed pin 52 may be received in the slots 55a of the lifting shaft 55. Accordingly, the lifting shaft 55 may move along the connection shaft 51 through the pair of slots 55a and the fixed pin 52.

When the plurality of first upper inner alignment members 21 and the plurality of second upper inner alignment members 22 move radially inward of the upper inner housing 23, and the plurality of first middle inner alignment members 31 and the plurality of second middle inner alignment members 32 move radially inward of the middle inner housing 33, the inner diameter of the annular space between the inner ring 11 and the outer ring 12 may be relatively reduced.

When the plurality of first upper inner alignment members 21 and the plurality of second upper inner alignment members 22 move radially outward of the upper inner housing 23, and the plurality of first middle inner alignment members 31 and the plurality of second middle inner alignment members 32 move radially outward of the middle inner housing 33, the inner diameter of the annular space between the inner ring 11 and the outer ring 12 may be relatively increased.

As described above, the upper inner alignment unit 20 and the middle inner alignment unit 30 of the inner alignment mechanism 10 may vary the inner diameter of the annular space between the inner ring 11 and the outer ring 12 so that the hairpin preliminary alignment jig according to an embodiment of the present disclosure may be able to precisely align the innermost layer hairpins in response to various models (types) of hairpin stators.

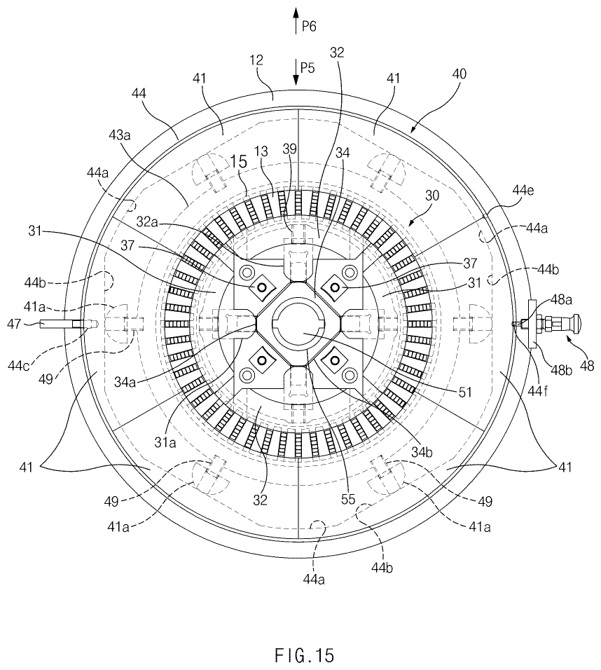

Referring to FIGS. 14 and 15, the hairpin preliminary alignment jig according to an embodiment of the present disclosure may include an outer alignment mechanism 40 configured to align the outermost layer hairpins among the plurality of hairpins received in the plurality of gaps 15. The outer alignment mechanism 40 may be disposed on the outer ring 12, and the outer alignment mechanism 40 may be spaced apart radially outward from the inner alignment mechanism.

The outer alignment mechanism 40 may include an outer housing 43, and a plurality of outer alignment members 41 movable radially with respect to the outer ring 12 and the outer housing 43.

The outer housing 43 may be fixed to a top surface of the outer ring 12, and an inner diameter of the outer housing 43 may be equal to or similar to an inner diameter of the outer ring 12.

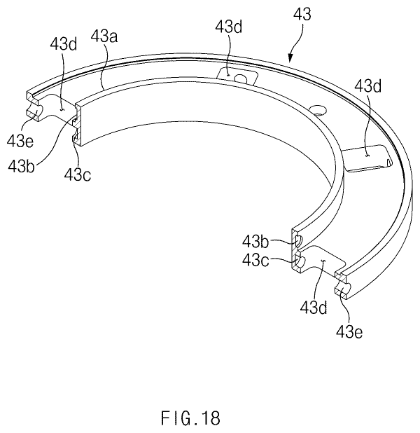

Referring to FIG. 18, the outer housing 43 may have a ring shape, and the outer housing 43 may include an annular wall 43a provided at an inner peripheral edge thereof. The annular wall 43a may extend annularly along the inner peripheral edge of the outer housing 43.

The outer housing 43 may have a plurality of openings 43d, and the plurality of openings 43d may correspond to the plurality of outer alignment members 41, respectively. The outer housing 43 may have a plurality of retainer recesses 43b formed in an outer peripheral surface of the annular wall 43a. The plurality of retainer recesses 43b may correspond to the plurality of outer alignment members 41, respectively. The outer housing 43 may have a plurality of inner peripheral recesses 43c formed in the inner peripheral edge thereof, and the plurality of inner peripheral recesses 43c may correspond to the plurality of outer alignment members 41, respectively. The outer housing 43 may have a plurality of outer peripheral recesses 43e formed in an outer peripheral edge thereof, and the outer peripheral recesses 43e may be aligned with the inner peripheral recesses 43c along the radial direction of the outer housing 43. The inner peripheral recesses 43c may be located below the retainer recesses 43b, and the retainer recesses 43b, the inner peripheral recesses 43c, and the outer peripheral recesses 43e may be aligned with the corresponding openings 43d.

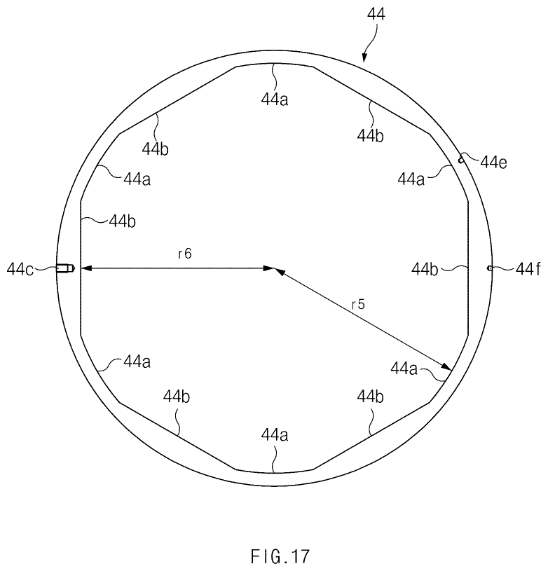

Referring to FIGS. 14 and 15, the outer alignment mechanism 40 may include an outer cam 44 mounted rotatably on the outer peripheral edge of the outer housing 43. Referring to FIG. 17, the outer cam 44 may have a ring shape having a plurality of first cam surfaces 44a and a plurality of second cam surfaces 44b formed on an inner peripheral edge thereof. The plurality of first cam surfaces 44a and the plurality of second cam surfaces 44b may be arranged alternately along the inner peripheral edge of the outer cam 44. A distance r5 between the first cam surface 44a and the center of the outer cam 44 may be different from a distance r6 between the second cam surface 44b and the center of the outer cam 44. According to an embodiment, the first cam surface 44a may be curved with a predetermined radius of curvature, and the second cam surface 44b may be a flat surface. The distance r5 between the first cam surface 44a and the center of the outer cam 44 may be greater than the distance r6 between the second cam surface 44b and the center of the outer cam 44. Accordingly, the first cam surface 44a may be located farther from the center of the outer cam 44 than the second cam surface 44b. The plurality of first cam surfaces 44a and the plurality of second cam surfaces 44b may be configured to selectively contact the plurality of outer alignment members 41 by the rotation of the outer cam 44.

The plurality of outer alignment members 41 may be configured to align the outermost layer hairpins among the plurality of hairpins received in the plurality of gaps 15. Referring to FIG. 14, the plurality of outer alignment members 41 may be configured to move radially in the outer housing 43. The radial movement of the plurality of outer alignment members 41 may be guided by a plurality of guide pins 46. As the plurality of outer alignment members 41 move in the radial direction, an outer diameter of the annular space between the inner ring 11 and the outer ring 12 may be varied.

The plurality of outer alignment members 41 may be arranged alternately along a circumferential direction of the outer housing 43 with respect to the center of the outer housing 43.

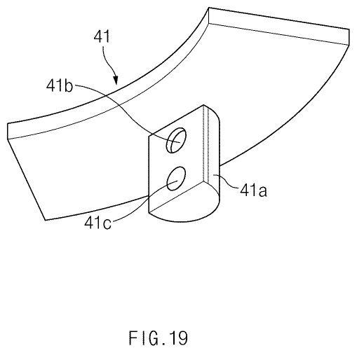

Referring to FIG. 19, each outer alignment member 41 may have a protrusion 41a protruding downward from a bottom surface thereof. The outer alignment member 41 may include a retainer recess 41b formed in an upper portion of the protrusion 41a, and a guide hole 41c located below the retainer recess 41b. Referring to FIGS. 14 and 15, the protrusion 41a of the outer alignment member 41 may be spaced apart radially outward from the annular wall 43a the outer housing 43.

Referring to FIG. 14, the outer alignment mechanism 40 according to an embodiment of the present disclosure may include the plurality of guide pins 46 guiding the radial movement of the plurality of outer alignment members 41, respectively. Each guide pin 46 may extend in the corresponding opening 43d of the outer housing 43 in the radial direction of the outer housing 43. One end of the guide pin 46 may be engaged to the inner peripheral recess 43c of the outer housing 43 and the other end of the guide pin 46 may be engaged to the outer peripheral recess 43e of the outer housing 43. The guide pin 46 may extend through the guide hole 41c of the outer alignment member 41. The outer alignment member 41 may move along the guide pin 46 in the radial direction of the outer housing 43.

Referring to FIG. 15, the protrusion 41a of the outer alignment member 41 may selectively contact the first cam surface 44a and the second cam surface 44b of the outer cam 44 by the rotation of the outer cam 44.

Referring to FIGS. 14 and 15, each outer alignment member 41 may be biased radially outward by a biasing member 49. Referring to FIG. 14, the biasing member 49 may be a coil spring disposed between the annular wall 43a of the outer housing 43 and the protrusion 41a of the outer alignment member 41. The outer alignment member 41 may be biased radially inward by the biasing member 49. The retainer recess 43b of the outer housing 43 may face the corresponding retainer recess 41b of the outer alignment member 41. One end of the biasing member 49 may be supported to the retainer recess 43b of the outer housing 43 and the other end of the biasing member 49 may be supported to the retainer recess 41b of the outer alignment member 41.

When the first cam surface 44a of the outer cam 44 contacts the protrusion 41a of the outer alignment member 41 by the rotation of the outer cam 44, the outer alignment member 41 may move radially outward (see P6 in FIGS. 14 and 15) of the outer housing 43 by extension of the biasing member 49. The outer alignment member 41 may be in a first position relatively far from the center of the outer housing 43.

When the second cam surface 44b of the outer cam 44 contacts the protrusion 41a of the outer alignment member 41 by the rotation of the outer cam 44, the outer alignment member 41 may move radially inward (see P5 in FIGS. 14 and 15) of the outer housing 43. As the biasing member 49 is compressed, the outer alignment member 41 may move to a second position relatively close to the center of the outer housing 43.

Referring to FIG. 17, the outer cam 44 may have an engagement recess 44c formed in an outer peripheral edge thereof. Referring to FIGS. 14 and 15, a handle 47 may be screwed into the engagement recess 44c. As the operator holds and turns the handle 47 of the outer cam 44, the outer cam 44 may be manually rotated.

Referring to FIG. 17, the outer cam 44 may have at least two positioning holes 44e and 44f formed in the outer peripheral edge thereof. The two positioning holes 44e and 44f may be spaced apart from each other by a predetermined gap. Specifically, a first positioning hole 44e may be aligned with a central portion of the first cam surface 44a, and a second positioning hole 44f may be aligned with a central portion of the second cam surface 44b. Accordingly, the first and second positioning holes 44e and 44f may be spaced apart from each other at an angle corresponding to an angle between the first cam surface 44a and the second cam surface 44b of the outer cam 44. Referring to FIGS. 14 and 15, an indexing plunger 48 may be mounted on the outer annular portion 12a of the outer ring 12 through a mounting bracket 48b. The indexing plunger 48 may have a positioning pin 48a configured to move forward and backward.

When the plurality of outer alignment members 41 contact any one of the first cam surface 44a and the second cam surface 44b of the outer cam 44 by the rotation of the outer cam 44, the positioning pin 48a of the indexing plunger 48 may be inserted into any one of the two positioning holes 44e and 44f. Thus, the outer alignment members 41 and the outer cam 44 may be accurately positioned.

When the plurality of outer alignment members 41 move radially inward of the outer housing 43, the outer diameter of the annular space between the inner ring 11 and the outer ring 12 may be relatively reduced. When the plurality of outer alignment members 41 move radially outward of the outer housing 43, the outer diameter of the annular space between the inner ring 11 and the outer ring 12 may be relatively increased. As described above, the outer alignment mechanism 40 may vary the outer diameter of the annular space between the inner ring 11 and the outer ring 12 so that the hairpin preliminary alignment jig according to an embodiment of the present disclosure may be able to precisely align the outermost layer hairpins in response to various models (types) of hairpin stators.

As set forth above, the hairpin preliminary alignment jig according to embodiments of the present disclosure may be designed to vary the inner and outer diameters of the annular space between the inner ring and the outer ring. As a result, the hairpin preliminary alignment jig may flexibly respond to various models of hairpin stators.

According to embodiments of the present disclosure, the upper inner alignment unit and the middle inner alignment unit of the inner alignment mechanism may vary the inner diameter of the annular space between the inner ring and the outer ring so that the hairpin preliminary alignment jig may be able to precisely align the innermost layer hairpins in response to various models of hairpin stators.

According to embodiments of the present disclosure, the outer alignment mechanism may vary the outer diameter of the annular space between the inner ring and the outer ring so that the hairpin preliminary alignment jig may be able to precisely align the outermost layer hairpins in response to various models of hairpin stators.

Hereinabove, although the present disclosure has been described with reference to embodiments and the accompanying drawings, the present disclosure is not limited thereto. Instead, the present disclosure may be variously modified and altered by those having ordinary skill in the art to which the present disclosure pertains without departing from the spirit and scope of the present disclosure claimed in the following claims.

What is claimed is:

1. A hairpin preliminary alignment jig, comprising:
an inner ring;
an outer ring spaced apart radially outward from the inner ring;
a plurality of radial members arranged radially between the inner ring and the outer ring and configured to define a plurality of gaps;
an inner alignment mechanism disposed on the inner ring, and including a plurality of inner alignment members configured to align innermost layer hairpins among a plurality of hairpins received in the plurality of gaps; and
an outer alignment mechanism disposed on the outer ring, and including a plurality of outer alignment members configured to align outermost layer hairpins among the plurality of hairpins received in the plurality of gaps.

2. The hairpin preliminary alignment jig according to claim 1, wherein the plurality of inner alignment members is configured to move in a radial direction of the inner ring.

3. The hairpin preliminary alignment jig according to claim 1, wherein the inner alignment mechanism includes: an inner housing disposed on the inner ring, and an inner cam mounted rotatably on a center of the inner housing, and
wherein the plurality of inner alignment members is configured to move radially in the inner housing by rotation of the inner cam.

4. The hairpin preliminary alignment jig according to claim 3, wherein the inner cam has a plurality of first cam surfaces and a plurality of second cam surfaces arranged alternately along an outer surface thereof, and
wherein a distance between the first cam surface and a center of the inner cam is different from a distance between the second cam surface and the center of the inner cam.

5. The hairpin preliminary alignment jig according to claim 3, wherein the inner housing has a plurality of guide blocks provided on a top surface thereof, and
wherein each guide block of the plurality of guide blocks is configured to guide the movement of each inner alignment member of the plurality of inner alignment members.

6. The hairpin preliminary alignment jig according to claim 3, wherein each inner alignment member of the plurality of inner alignment members is biased radially inward by a biasing member.

7. The hairpin preliminary alignment jig according to claim 6, wherein each biasing member is disposed between each respective inner alignment member and the inner housing.

8. The hairpin preliminary alignment jig according to claim 7, wherein the inner housing has an annular wall provided at an outer peripheral edge thereof,
wherein each inner alignment member has a protrusion protruding from a bottom surface thereof, and
wherein each biasing member is disposed between the protrusion of each respective inner alignment member and the annular wall of the inner housing.

9. The hairpin preliminary alignment jig according to claim 1, wherein the inner alignment mechanism includes: an upper inner alignment unit configured to align upper portions of the innermost layer hairpins, and a middle inner alignment unit configured to align middle portions of the innermost layer hairpins, and
wherein the middle inner alignment unit is connected to the upper inner alignment unit through a connection shaft.

10. The hairpin preliminary alignment jig according to claim 1, wherein the plurality of outer alignment members is configured to move in a radial direction of the outer ring.

11. The hairpin preliminary alignment jig according to claim 1, wherein the outer alignment mechanism includes: an outer housing fixed to a top surface of the outer ring, and an outer cam mounted rotatably on an outer peripheral edge of the outer housing, and
wherein the plurality of outer alignment members is configured to move radially in the outer housing by rotation of the outer cam.

12. The hairpin preliminary alignment jig according to claim 11, wherein the outer cam has a plurality of first cam surfaces and a plurality of second cam surfaces arranged alternately along an inner peripheral edge thereof, and
wherein a distance between the first cam surface and a center of the outer cam is different from a distance between the second cam surface and the center of the outer cam.

13. The hairpin preliminary alignment jig according to claim 11, further comprising: a plurality of guide pins configured to guide the movement of the plurality of outer alignment members,
wherein each guide pin of the plurality of guide pins extends radially in the outer housing.

14. The hairpin preliminary alignment jig according to claim 11, wherein each outer alignment member of the plurality of outer alignment members is biased radially outward by a biasing member.

15. The hairpin preliminary alignment jig according to claim 14, wherein each biasing member is disposed between each respective outer alignment member and the outer housing.

16. The hairpin preliminary alignment jig according to claim 14, wherein the outer housing has an annular wall provided at an inner peripheral edge thereof,
wherein each outer alignment member has a protrusion protruding from a bottom surface thereof, and
wherein each biasing member is disposed between the protrusion of each respective outer alignment member and the annular wall of the outer housing.
